(19) United States
(12) Patent Application Publication
(10) Pub. No.: US 2017/0062784 A1
(43) Pub. Date: Mar. 2, 2017

(54) BI-LAYER SEPARATOR AND METHOD OF MAKING THE SAME

(71) Applicant: GM GLOBAL TECHNOLOGY OPERATIONS LLC, Detroit, MI (US)

(72) Inventors: Hamid G. Kia, Bloomfield Hills, MI (US); Xiaosong Huang, Novi, MI (US)

(21) Appl. No.: 14/838,733

(22) Filed: Aug. 28, 2015

(51) Int. Cl. H01M 2/14; H01M 10/0525; H01M 2/16

(52) U.S. Cl. CPC H01M 2/145; H01M 2/1686; H01M 10/0525; H01M 2220/30

(57) ABSTRACT

In an example of a method for making a bi-layer separator, a polymer solution is coated on a sacrificial support or a carrier belt to form a polymer solution layer. A porous membrane is established on the polymer solution layer. At least some of the polymer solution layer is solidified to form a porous polymer coating adjacent to the porous membrane. The porous polymer coating and the porous membrane together form the bi-layer separator.

### BACKGROUND

Secondary, or rechargeable, lithium batteries are often used in many stationary and portable devices, such as those encountered in the consumer electronic, automobile, and aerospace industries. The lithium class of batteries has gained popularity for various reasons, including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

Method(s) for making a bi-layer separator are disclosed herein. In an example of the method for making the bi-layer separator, a polymer solution is coated on a sacrificial support or a carrier belt to form a polymer solution layer. A porous membrane is established on the polymer solution layer. At least some of the polymer solution layer is solidified to form a porous polymer coating adjacent to the porous membrane. The porous polymer coating and the porous membrane together form the bi-layer separator.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A through 1G are schematic, cross-sectional views which together illustrate two examples of the method for forming an example of the bi-layer separator disclosed herein;

FIG. 2 is a schematic, cross-sectional view of another example of the bi-layer separator disclosed herein;

FIG. 3 is a schematic diagram of an example of a system for forming examples of the bi-layer separator disclosed herein;

FIGS. 4A and 4B are black and white representations of originally colored photographs of a comparative example of a separator formed with a polymer solution coated on a porous membrane; and

FIGS. 5A-5C are black and white representations of originally colored photographs of three different examples of the bi-layer separator disclosed herein.

### DETAILED DESCRIPTION

Examples of the method disclosed herein utilize a sacrificial substrate or carrier/conveyor belt and phase inversion to form a bi-layer separator.

During the method(s), the sacrificial substrate or carrier belt has a polymer solution coated thereon. Any tension resulting from the coating process is applied to the sacrificial substrate or carrier belt, and not to a subsequently applied porous membrane. As such, examples of the method disclosed herein avoid causing damage to the porous membrane as a result of coating tension. Since the polymer solution is coated on the sacrificial substrate or carrier belt, and not on the subsequently applied porous membrane, the porous membrane is not exposed to the tool(s) utilized in the coating process. For example, the porous membrane is not squeezed through a small gap between a coating die and a back roll, and also does not contact the coating die. This lack of contact eliminates the possibility that the coating die will strip, rip, tear, etc. the porous membrane during the coating process.

During the method(s), after the polymer solution is coated on the sacrificial substrate or carrier belt, the porous membrane is established on the polymer solution. Phase inversion of the polymer solution is then initiated through the pores in the porous membrane. By initiating phase inversion in this manner, the polymer solution that is directly in contact with the porous membrane will precipitate first. This results in the formation of a porous polymer coating that is in direct contact with, and has good adhesion to the porous membrane.

The bi-layer separator formed via the method(s) disclosed herein includes the porous membrane and the porous polymer coating. The porous polymer coating is at least adjacent to one of the outer surfaces of the porous membrane. The porous polymer coating also substantially covers at least some of the pore walls or fiber surfaces of the porous membrane. In these instances, the porous polymer coating is in a position that effectively blocks the pores of the porous membrane. It is to be understood that the pores of the porous polymer coating are significantly smaller than the pores of the porous substrate. As such, the porous polymer coating blocks the passage of undesirable species (e.g., lithium dendrites, conductive fillers (e.g., carbon black), or lithium-polysulfide intermediates (LiSₓ, where x is 2<x<8)) through the bi-layer separator.

In addition, since the bi-layer separator is porous, it does not need to be exposed to additional stretching in order to create pores. Films that are not exposed to stretching processes are less likely to shrink when exposed to heat, and thus the risk of battery shorting is reduced.

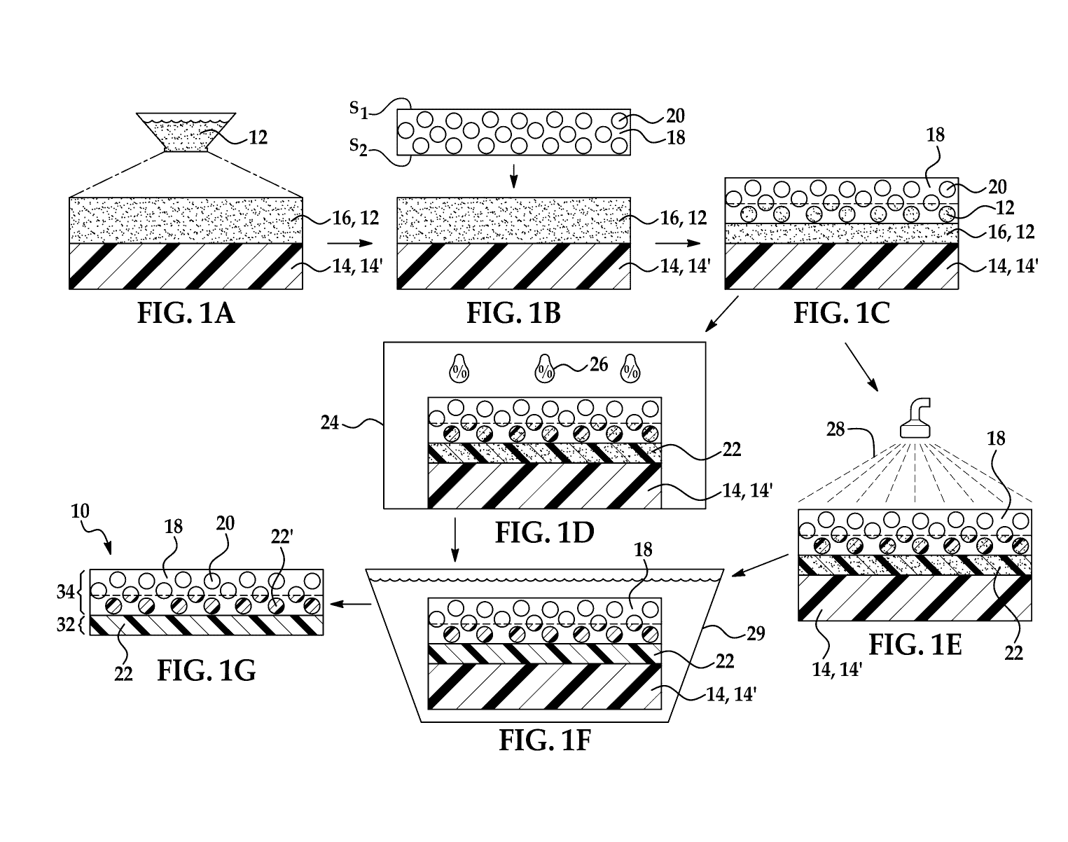

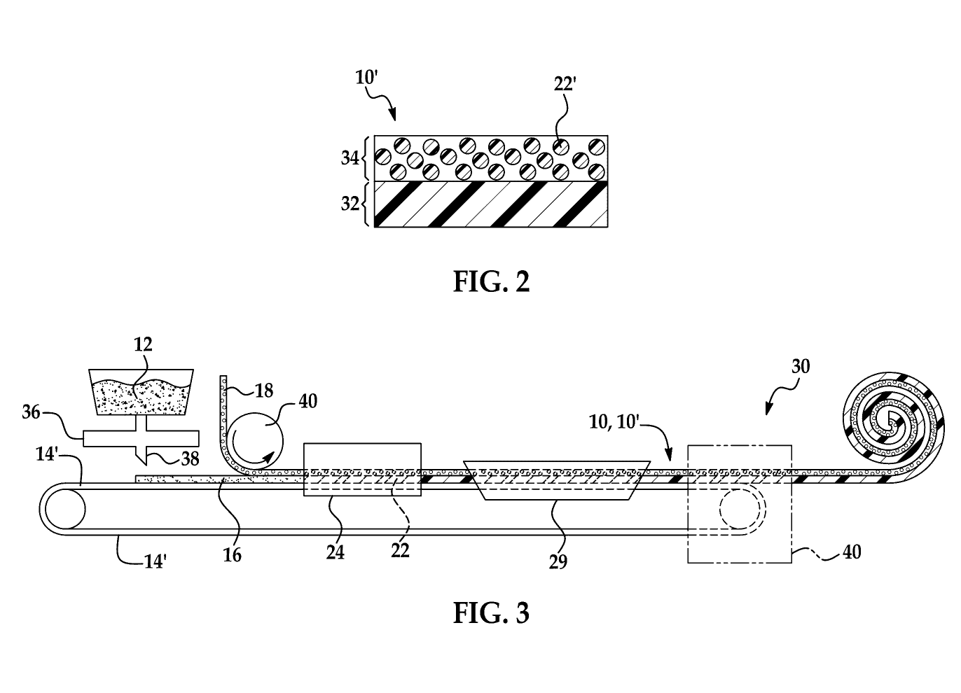

FIGS. 1A through 1G schematically depict a flow diagram of various examples of the method for forming an example of the bi-layer separator 10 (shown in FIG. 1G). FIG. 2 illustrates another example of the bi-layer separator 10′ that may be formed.

As shown in FIG. 1A, a polymer solution 12 is coated onto a sacrificial support 14 or a carrier belt 14′. Prior to coating the polymer solution 12 on the sacrificial support 14 or the carrier belt 14′, the polymer solution 12 is either made or purchased. The polymer solution 12 (whether made or purchased) includes at least one polymer dissolved in a solvent. In some examples, the polymer solution 12 also includes inorganic particles.

In examples of the polymer solution 12, the polymer may be any thermally stable material having a melting temperature greater than 150° C. In some instances, the polymer has a melting temperature greater than 200° C. As examples, the polymer is selected from polyimides, poly(amic acid), polysulfone (PSF), polyphenylsulfone (PPSF), polyethersulfone (PESF), polyamides, polyvinylidene fluoride (PVDF), polyacrylonitrile (PAN), poly(methyl methacrylate) (PMMA), polyolefins (e.g., polyethylene, polypropylene, etc.), cellulose or cellulose acetate. Examples of polyamides include aliphatic polyamides, semi-aromatic polyamides, or aramids (e.g., meta-aramid). An example of a suitable polyimide is polyetherimide (PEI). The polymer may be present in the polymer solution 12 in an amount ranging from about 3% to about 50% of the total wt % of the polymer solution 12.

The solvent used depends upon the polymer used, and will be selected so that it dissolves the selected polymer. In an example, when PVDF is used as the polymer, the solvent may be acetone, N-methyl-2-pyrrolidone (NMP), dimethyl sulfoxide (DMSO), tetrahydrofuran (THF), dimethylformamide (DMF), or butanone. In another example, when a polyamide (e.g., meta-aramid) is used as the polymer, the solvent may be N-methyl-2-pyrrolidone (NMP) containing LiCl or CaCl₂, dimethylacetamide (DMAc) containing LiCl or CaCl₂, dimethylformamide (DMF), dimethyl sulfoxide containing LiCl or CaCl₂, or tetramethylurea (TMU). In yet another example, in some instances when an aromatic or semi-aliphatic polyimide is used as the polymer, the solvent may be N-methyl-2-pyrrolidone (NMP), dimethyl sulfoxide (DMSO), and dimethylformamide (DMF). In a further example, when a polysulfone is the polymer, the solvent may be a ketone, such as acetone, a chlorinated hydrocarbon, such as chloroform, aromatic hydrocarbons, N-methyl-2-pyrrolidone (NMP), or dimethyl sulfoxide (DMSO). Some specific examples of a polymer-solvent system include PVDF as the polymer and acetone as the solvent. In another example, the polymer is polyetherimide or meta-aramid and the solvent is N-methyl-2-pyrrolidone (NMP), dimethylacetamide (DMAc), dimethylformamide (DMF), dimethyl sulfoxide containing LiCl or CaCl₂, N-methyl-2-pyrrolidone (NMP) containing LiCl or CaCl₂, or dimethylformamide (DMF) containing LiCl or CaCl₂. When LiCl or CaCl₂ is added to or present in the solvent, a suitable amount of the salt may be up to 20% of the total wt % of the polymer solution 12.

In examples of the polymer solution 12 that include inorganic particles, the inorganic particles have a particle size/diameter (or average diameter if irregularly shaped) of less than 2 μm. In another example, the inorganic particles have a particle size/diameter ranging from about 5 nm to about 1 μm. The amount of inorganic particles depends, in part, on the amount of polymer used in the polymer solution. In an example, the inorganic particles may be present in an amount ranging from 10 wt % to about 1000 wt % of the total wt % of the polymer in the polymer solution. Some examples of the inorganic particles include alumina, silica, titania or combinations thereof.

As mentioned above, the polymer solution 12 is coated onto the sacrificial support 14 or the carrier belt 14′. The sacrificial support 14 or carrier belt 14′ may be formed of any material that enables a porous polymer coating formed thereon to be removed therefrom. As an example, the sacrificial support 14 or carrier belt 14′ may be formed of a polyethylene terephthalate (PET) film having a thickness ranging from about 25 μm to about 200 μm. It is to be understood that after the porous polymer coating is formed and removed, the sacrificial support 14 or carrier belt 14′ may be reused.

The polymer solution 12 may be coated on the sacrificial support 14 or carrier belt 14′ to form a polymer solution layer 16. The polymer solution 12 may be applied via a spray coating process, a die coating process, a roll-to-roll coating process, or a dip coating process. The thickness of the applied polymer solution layer 16 may be controlled via any suitable mechanism, including a pump and meter, a doctor blade, or the like, or combinations thereof. In one example, the thickness of the applied polymer solution layer 16 ranges from about 10 μm to about 1 mm.

Referring now to FIGS. 1B and 1C together, a porous membrane 18 is established on the polymer solution layer 16. The porous membrane 18 includes a first side S₁, a second side S_{2,} and pores 20 throughout a thickness of the porous membrane 18. Each of the first and second sides S₁, S₂ forms an exterior surface of the porous membrane 18 and is defined by fibers and pores 20 of the porous membrane 18. The pores 20 of the porous membrane 18 may have a pore diameter (or average diameter if irregularly shaped) ranging from about 0.1 μm to about 30 μm.

Some examples of the porous membrane 18 are formed of cellulose fibers, polyethylene naphthalate fibers, aramid fibers (i.e., aromatic polyamide), polyimide fibers, polyethylene terephthalate (PET) fibers, inorganic fibers (e.g., alumina and/or silica), or polyolefin fibers. One specific example of the porous membrane 18 is a non-woven cellulose fiber mat.

To establish the porous membrane 18 on the polymer solution layer 16, the porous membrane 18 may be laid on the polymers solution layer 16, pressed into the polymer solution layer 16, or otherwise placed into contact with the polymer solution layer 16.

When the porous membrane 18 is established on the polymer solution layer 16, the polymer solution 12 at least is in contact with the fibers that define the first side S₁ of the porous membrane 18. The polymer solution 12 in the layer 16 may also penetrate/imbibe into at least some of the pores 20 of the porous membrane 18 (e.g., those located at or near the first side S₁). In some instances, the polymer solution 12 in the layer 16 penetrates/imbibes into most of the pores 20 of the porous membrane 18. As an example, from about 5% of the pores to about 99% of the pores of the porous membrane 18 may be wetted by the polymer solution 12. The percentage of pores 20 that become at least partially filled or wetted with the polymer solution 12 may depend, in part, upon the thickness of the polymer solution layer 16, the thickness of the porous membrane 18, the viscosity of the polymer solution 12, the wettability of the porous membrane 18 by the polymer solution 12, and/or the amount of force that is applied to the porous membrane 18 when it is established. For example, the polymer solution layer 16 may be thicker than the porous membrane 18, and the porous membrane 18 may be laid on the polymer solution layer 16 with a slight force. In this instance, some of the polymer solution 12 may penetrate into the pores 20 adjacent to the first side S₁ as well as pores 20 positioned further away from the first side S₁, and some of the polymer solution layer 16 may remain between the sacrificial substrate 14 or carrier belt 14′ and the porous membrane 18. In the example shown in FIG. 1C, the polymer solution 12 in the layer 16 penetrates some, but not all, of the pores 20 of the porous membrane 20.

The solidification of the polymer solution 12 in the pores 20 forms a porous polymer phase 22′ in the pores 20, and the solidification of the remaining polymer solution layer 16 forms a porous polymer coating 22 adjacent to the porous membrane 18. Examples of the solidification process are shown in FIGS. 1D and 1E. Generally, the solidification is accomplished by introducing the non-solvent through the pores 20 of the porous membrane 18 that are adjacent to the second side S₂. By introducing the non-solvent through the pores 20, the non-solvent contacts the polymer solution 12 that is present in at least some of the pores 20 first, and then contacts the polymer solution layer 16 that remains adjacent to the first side S₁. As such, the non-solvent initiates phase inversion of the polymer in the pores 20 first, and then initiates phase inversion of the polymer solution layer 16 that remains between the porous membrane 18 and the sacrificial support 14 or carrier belt 14′. Phase inversion causes the polymer to precipitate out of the solution 12, and the solid polymer forms the porous polymer phase 22′ and the porous polymer coating 22.

In FIG. 1D, non-solvent exposure is accomplished in a humidity chamber 24. When the humidity chamber 24 is used, the non-solvent is water vapor 26. In an example when the humidity chamber 24 is used, the humidity chamber 24 has a relative humidity of greater than 50%. At a relative humidity of >50%, the time for humidity exposure may be at least 5 seconds. The time for exposure may vary, depending upon the relative humidity and/or the polymer in the polymer solution 12. As an example, the polymer in the polymer solution 12 may be polyetherimide, the relative humidity in the chamber 24 may be 90%, and the exposure time may be about 30 seconds. As another example, the polymer in the polymer solution 12 may be meta-aramid, the relative humidity in the chamber 24 may be 90%, and the exposure time may be about 3 minutes. Inside the humidity chamber 24, water vapor 26 travels into the pores 20 of the porous membrane 18, and ultimately contacts the polymer solution 12 in the pores 20 and then the remaining polymer solution layer 16, which causes the polymer therein to precipitate out to form the porous polymer phase 22′ and the porous polymer coating 22.

In FIG. 1E, non-solvent exposure is accomplished by spraying or otherwise applying non-solvent droplets 28 directly to the side surface S₂ of the porous membrane 18 having the pores 20. Water may be used as the non-solvent droplets 28 for all of the polymers disclosed herein. In some instances, alcohols (e.g., ethanol or isopropanol), or combinations of water and alcohol(s) may also be used as non-solvent droplets. As an example of the method shown in FIG. 1E, a polymer solution 12 including PVDF may be exposed to water droplets 28 that are sprayed into the pores 20 of the porous membrane 18. The non-solvent droplets 28 may be sprayed for a time that is suitable to perform phase inversion. Generally, the non-solvent droplets 28 may be sprayed for a time ranging from about 2 seconds to about 3 minutes. As an example, a polymer solution 12 including polyetherimide dissolved in NMP may be exposed to the sprayed non-solvent droplets 28 for a time ranging from about 2 seconds to about 1 minute. In another example, a polymer solution 12 including meta-aramid dissolved in NMP containing LiCl or CaCl₂ may be exposed to the sprayed non-solvent droplets 28 for a time ranging from about 5 seconds to about 1 minute. In the example shown in FIG. 1E, the non-solvent travels into the pores 20 of the porous membrane 18 and ultimately contacts the polymer solution 12 in the pores 20 and the polymer solution layer 16 adjacent to the polymer membrane 18, which causes the polymer therein to precipitate out to form the porous polymer phase 22′ and the porous polymer coating 22.

The composition of the porous polymer phase 22′ and the porous polymer coating 22 will depend upon the polymer in the polymer solution 12. For example, the porous polymer phase 22′ and the porous polymer coating 22 may be formed of PVDF, polyetherimide, meta-aramid, or any of the other polymers disclosed herein. These polymer materials are thermally stable materials, and thus can improve the battery abuse tolerance of the bi-layer separator.

After solidification, the porous polymer coating 22 and the porous membrane 18 (having the porous polymer phase 22′) may be exposed to additional processing in order to extract and/or wash away any remaining solvent and/or non-solvent. As shown in FIG. 1F, this may be accomplished using a water bath 29. The temperature of the bath 29 may be room temperature (e.g., 20° C. to 25° C.) or higher (e.g., 30° C. to 90° C.). Residual solvent and/or non-solvent may also be removed by vacuum drying, evaporation, or another suitable technique. The porous polymer coating 22 and the porous membrane 18 may be exposed to the solvent and/or non-solvent removal process(es) for any suitable time period to achieve removal. In one example, the porous polymer coating 22 and the porous membrane 18 remain in the bath 29 for a time ranging from about 1 second to about 30 minutes. In some other examples, the porous polymer coating 22 and the porous membrane 18 are exposed to both the water bath 29 and drying at elevated temperatures (e.g., ranging from about 60° C. to about 140° C.) in an oven or other drying chamber (not shown in FIGS. 1A-1G).

The porous polymer phase 22′ and the porous polymer coating 22 in the bi-layer separator 10 are made up of the dried, precipitated polymer. After drying, the bi-layer separator 10 is separated from the sacrificial support 14 or carrier belt 14′. The bi-layer separator 10 may be lifted, peeled, or otherwise removed from the sacrificial support 14 or carrier belt 14′.

An example of the bi-layer separator 10 is shown in FIG. 1G. In this example, the bi-layer separator 10 includes two layers 32, 34, one (i.e., porous polymer coating layer 32) of which includes the porous polymer coating 22 and the other (i.e., porous membrane layer 34) of which includes the porous membrane 18 having the porous polymer phase 22′ present in at least some of its pores 20. Since the polymer solution 12 from the layer 16 penetrates into some of the pores 20 prior to solidification and the non-solvent is introduced through the pores 20, the polymer solution 12 that is present in the pores 20 of the porous membrane 18 will solidify first. As such, the porous polymer phase 22′ is part of the porous membrane layer 32 of the bi-layer separator 10 in this example. The presence of the porous polymer phase 22′, which is in contact with both the porous membrane 18 and the porous polymer coating 22, may strengthen the adhesion between the two components 18, 22. In addition, the porous polymer phase 22′ reduces the size of the pores 20 (thus blocking undesirable components from passing through the pores 20) and improves the uniformity of the porous membrane 18.

In another example, the polymer solution 12 from the layer 16 penetrates almost all of the pores 20 prior to solidification. An example of this is shown in FIG. 2. In this example, the bi-layer separator 10 includes two layers 32, 34, similar to the layers shown in FIG. 1G, except that most of the pores 20 have the porous polymer phase 22′ therein.

The bi-layer separator 10, 10′ has several advantages. The porous membrane 18 provides suitable mechanical properties and thermal stability, and the porous polymer coating 22 and the polymer phase 22′ provides smaller pores (than the porous membrane 18), improves the overall uniformity, and offers the potential to improve the adhesion of the separator 10, 10′ with an adjacent electrode.

One example of a system 30 for forming examples of the bi-layer separator 10, 10′ is shown in FIG. 3. In this example, the carrier belt 14′ is configured to receive the polymer solution layer 16 via coating tools (e.g., a pump and meter 36, a doctor blade 38, etc.). After the polymer solution layer 16 is coated, a roller 40 moves the porous membrane 18 into contact with the polymer solution layer 16. The carrier belt 14′ then transports the polymer solution layer 16 having the porous membrane 18 thereon into the humidity chamber 24 or within proximity of a non-solvent spray mechanism (not shown). The polymer solution 12 (in the pores 20) and the polymer solution layer 16 (on the belt 14′) are exposed to the non-solvent through the pores 20 in the porous membrane 18, and the polymer precipitates out to form the porous polymer phase 22′ (not shown in FIG. 3) and the porous polymer coating 22. The carrier belt 16 then transports the porous polymer coating 22 and the porous membrane 18 (which has porous polymer phase 22′ in at least some of its pores 20) to the water bath 29 for removal of the residual solvent and/or non-solvent. After the water bath 29, the bi-layer separator 10, 10′ is formed, and may be removed from the carrier belt 14′. In some examples, the bi-layer separator 10, 10′ may also be transported to a drying chamber 40, where it is exposed to additional drying before being removed from the carrier belt 14′.

The carrier belt 16 and the various other components of the system 30 may be operatively connected to a central processing unit (not shown). The central processing unit (e.g., running computer readable instructions stored on a non-transitory, tangible computer readable storage medium) manipulates and transforms data within the system's registers and memories in order to control the parameters (e.g., dispensed amounts, exposure times, humidity levels, temperatures, carrier belt 14′ speed, etc.) of each of the components.

The bi-layer separator disclosed herein may be used in any lithium based battery, including a lithium sulfur battery, a lithium ion battery, and a lithium metal battery. The lithium sulfur battery includes a sulfur based positive electrode (e.g., a 1:9-9:1 sulfur:carbon composite) paired with a lithium or lithiated negative electrode (e.g., lithiated graphite, silicon, etc.). The lithium ion battery includes a lithium based positive electrode (e.g., layered lithium transition metal oxides) paired with a negative electrode (e.g., graphite, silicon, etc.) or a non-lithium positive electrode (other metal oxides, such as Mn₂O₄, CoO₂, FePO₄, FePO₄F, or V₂O₅) paired with a lithium or lithiated negative electrode. The lithium metal battery includes lithium based positive and negative electrodes. Each electrode may also include a polymer binder and/or a conductive filler.

The bi-layer separator is positioned between the positive and negative electrode, and all of the components are soaked in a suitable electrolyte solution for the particular battery. The respective electrodes may be connected to suitable current collectors, which may be electrically connected to an external circuit and a load.

The wettability between the bi-layer separator 10, 10′ and the electrolyte may be enhanced, due to the polar nature of the porous polymer phase 22′ and the porous polymer coating 22. Improved wettability may improve the battery cycling performance.

To further illustrate the present disclosure, examples are given herein. It is to be understood that these examples are provided for illustrative purposes and are not to be construed as limiting the scope of the present disclosure.

### EXAMPLES

### Example 1

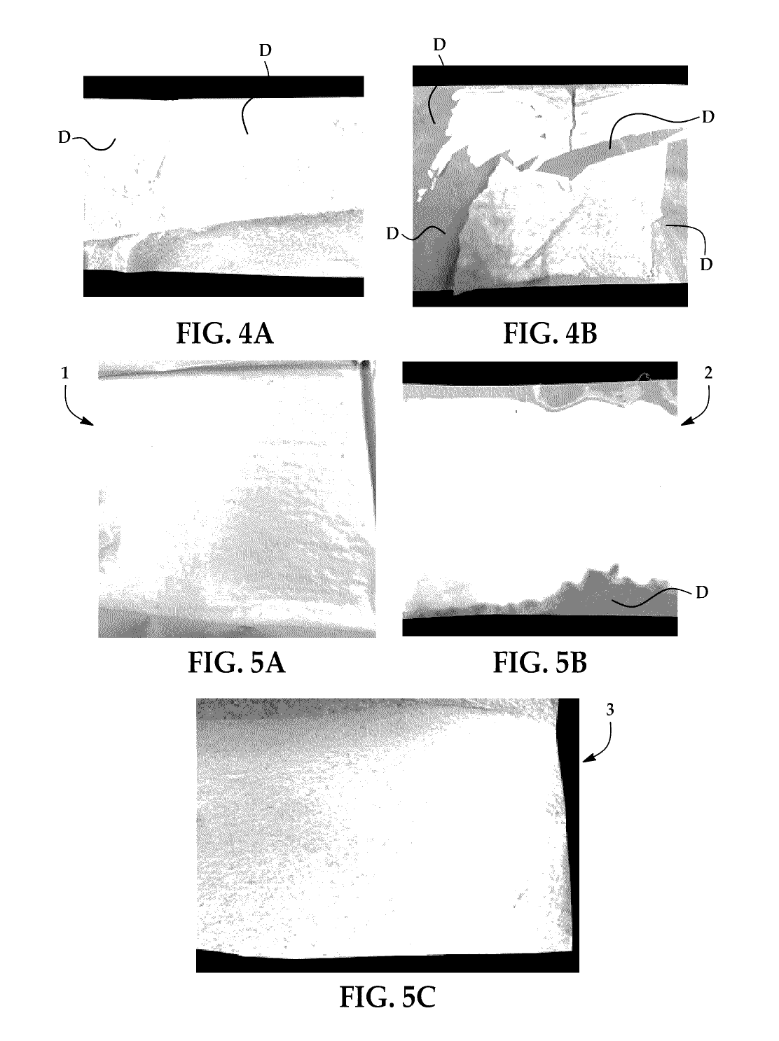

A comparative example separator (shown in FIGS. 4A and 4B), and three examples of the bi-layer separator disclosed herein (1, 2, and 3 shown in FIGS. 5A-5C, respectively) were prepared. Cellulose non-woven fiber mats and a PET mat were used as the non-woven substrates. More particularly, the comparative example separator was formed with a cellulose non-woven fiber mat, the example separators 1 and 3, shown in FIGS. 5A and 5C, were formed with cellulose mats, and the example separator 2, shown in FIG. 5B, was formed with a PET mat.

A polymer solution was prepared by adding meta-aramid as the polymer to N-methyl-2-pyrrolidone (NMP), containing 10 wt % CaCl₂, as the solvent. More particularly, the polymer solution had 8 parts of meta-aramid and 100 parts of NMP with CaCl₂.

In the comparative example shown in FIGS. 4A and 4B, the meta-aramid polymer solution was die coated directly onto one side of the cellulose non-woven substrate.

For the example separators 1, 2, 3, shown in FIGS. 5A-5C, the meta-aramid polymer solution was die coated onto a PET carrier belt to form a layer. For example separators 1 and 3, the cellulose non-woven substrates were laid down on different sections of the layer of the meta-aramid polymer solution. For example separator 2, the PET mat substrate was laid down on yet another section of the layer of the meta-aramid polymer solution.

After applying the meta-aramid polymer solution on the non-woven cellulose substrate (comparative example) and after applying the cellulose non-woven substrates on the meta-aramid polymer solution layer (examples 1 and 3), the comparative example separator, and the example separators 1 and 3 were transported into a humidity chamber with water vapor as the non-solvent. The humidity chamber had a relative humidity of 90% at a temperature of 30° C. The comparative separator and example separators 1 and 3 were left in the humidity chamber for 2 minutes. After applying the PET mat substrate on the meta-aramid polymer solution layer (example 2), the top of example separator 2 was exposed to an ethanol spray at 30° C. for 1 minute.

Exposure to the water vapor and the ethanol spray induced phase inversion, where the meta-aramid precipitated out of solution to form a porous polymer layer on the non-woven cellulose substrate of the comparative separators and to form a porous polymer layer beneath the non-woven cellulose substrate and the PET mat substrate of the example separators 1, 3, and 2. The example separators 1, 2, 3 also had a porous polymer phase present in at least some of the pores of the respective substrates.

Each of the comparative separators and the example separators 1, 2, 3 was subjected to a peel test to qualitatively determine how strong the porous polymer layer was bonded to the non-woven cellulose substrate or the PET mat substrate. As shown in FIGS. 4A and 4B, the porous meta-aramid layer was easily peeled away or delaminated from the non-woven cellulose substrate of the comparative examples. Several of the delaminated portions are labeled D. The example separators 1 and 3 shown in FIGS. 5A and 5C, which included the porous polymer coating formed beneath the non-woven cellulose substrate and the porous polymer phase in pores of the substrate, exhibited significant improvement in the adhesion between the porous meta-aramid layer and the non-woven cellulose substrate. As shown in FIGS. 5A and 5C, none of the non-woven cellulose substrate was able to be peeled away from the porous meta-aramid layer. The example separator 2 shown in FIGS. 5B, which included the porous polymer coating formed beneath the PET mat substrate and the porous polymer phase formed in pores of the PET mat substrate, also exhibited improved adhesion when compared to the comparative example. While some delamination occurred with example separator 2, it was much less than the comparative example shown in FIGS. 4A and 4B.

The non-solvent vapor travels through the pores of the substrate in the example separators 1, 2, 3, and is able to initiate precipitation at a point where the polymer solution first contacts the substrate. This is believed to improve the adhesion between the layers. Additionally, the substrates of the example separators are not exposed to the tension and tools of the polymer solution coating process. As a result, the separator has an increased durability compared to separators formed with the polymer solution coated on the non-woven cellulose substrate.

### Example 2

In Example 2, example separator 1 from Example 1 was utilized. Also in Example 2, a polypropylene separator (i.e., CELGARD® 2500) was utilized as the comparative example. CELGARD® 2500 is a power battery separator that is designed to enable good ionic conductivity.

In this example, an electrochemical cell was formed with the comparative separator and example separator 1. The cell was formed by sandwiching the comparative and example separators between two stainless steel electrodes and saturating the cell with a liquid electrolyte to fill the inter-electrode space. The electrolyte was 1M LiPF₆ in EC (ethylene carbonate)/DMC (dimethyl carbonate) in a 1:1 volume ratio. The electrochemical cell was cycled while measuring the bulk resistance on an SI 1260 impedance gain analyzer available from Solartron Analytical. The effective ionic conductivities were calculated for the comparative and example separators. The effective ionic conductivities (τ) were calculated from the following equation:

$$σ = \frac{d}{{R}_{b} \cdot S} = \frac{1}{ρ} \qquad ( I )$$

where d is the thickness of the separator, R_{b} is the bulk resistance, and S is the area of the electrode. The results are shown below in Table 1.

TABLE 1

| | Conductivity |
|---|---|
| Separator | (mS/cm) |
| Comparative | 1.47 |
| example | |
| Example | 1.58 |
| separator 1 | |

As depicted, the electrical performance of the example separator 1 disclosed herein is slightly better (in terms of conductivity) when compared to a polyolefin separator. This shows that the method disclosed herein can be used to make a separator that has comparable or better conductivity than the comparative example separator.

It is to be understood that the ranges provided herein include the stated range and any value or sub-range within the stated range. For example, a range of from 1:9 to 9:1 should be interpreted to include not only the explicitly recited limits of from 1:9 to 9:1, but also to include individual values, such as 1:2, 7:1, etc., and sub-ranges, such as from about 1:3 to 6:3 (i.e., 2:1), etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A method for making a bi-layer separator, the method comprising:
coating a polymer solution on a sacrificial support or a carrier belt to form a polymer solution layer;
establishing a porous membrane on the polymer solution layer; and
solidifying at least some of the polymer solution layer to form a porous polymer coating adjacent to the porous membrane, wherein the porous polymer coating and the porous membrane together form the bi-layer separator.

2. The method as defined in claim 1 wherein the solidifying of the at least some of the polymer solution layer is accomplished by introducing a non-solvent to the polymer solution layer through pores of the porous membrane, thereby inducing phase inversion in the polymer solution and causing a polymer in the polymer solution to precipitate out of the polymer solution to form the porous polymer coating adjacent to the porous membrane.

3. The method as defined in claim 2 wherein the polymer solution includes the polymer and a solvent, and wherein:
i) the polymer is polyvinylidene fluoride (PVDF), the solvent is acetone, and the non-solvent is an alcohol having 1 to 5 carbons, water or water vapor; or
ii) the polymer is polyetherimide or meta-aramid, the solvent is N-methyl-2-pyrrolidone (NMP), dimethylacetamide (DMAc), dimethylformamide (DMF), dimethyl sulfoxide containing LiCl or CaCl₂, N-methyl-2-pyrrolidone (NMP) containing LiCl or CaCl₂, or dimethylformamide (DMF) containing LiCl or CaCl₂, and the non-solvent is an alcohol having 1 to 5 carbons, water or water vapor.

4. The method as defined in claim 2 wherein the introducing of the non-solvent to the polymer solution layer through the pores of the porous membrane includes transporting the sacrificial support or the carrier belt, having the polymer solution layer and the porous membrane thereon, to a humid environment including a vapor of the non-solvent.

5. The method as defined in claim 2 wherein the introducing of the non-solvent to the polymer solution layer through the pores of the porous membrane includes applying the non-solvent on a surface of the porous membrane.

6. The method as defined in claim 1, further comprising transporting the sacrificial support or the carrier belt having the bi-layer separator thereon, into a water bath.

7. The method as defined in claim 1, further comprising separating the bi-layer separator from the sacrificial support or the carrier belt.

8. The method as defined in claim 1 wherein:
the polymer solution further includes inorganic particles selected from the group consisting of alumina, silica, titania, or combinations thereof; and
during the solidifying, the polymer and the inorganic particles are precipitated from the polymer solution.

9. The method as defined in claim 1 wherein the coating of the polymer solution is accomplished by die coating, dip coating, or spray coating.

10. The method as defined in claim 1 wherein the porous polymer coating forms on a surface of the porous membrane and in at least some pores of the porous membrane.

11. The method as defined in claim 1, further comprising making the polymer solution by dissolving a polymer in a solvent, wherein the polymer is present in the polymer solution in an amount ranging from about 3% to about 50% of a total wt % of the polymer solution.

12. The method as defined in claim 11, further comprising adding LiCl or CaCl₂ to the solvent in an amount up to 20% of the total wt % of the polymer solution.

13. The method as defined in claim 1 wherein during the establishing of the porous membrane on the polymer solution layer, the polymer solution imbibes into some of the pores of the porous membrane.

14. A method for making a bi-layer separator, the method comprising:
coating a polymer solution on a sacrificial support or a carrier belt to form a polymer solution layer;
establishing a porous membrane on the polymer solution layer;
introducing a non-solvent to the polymer solution layer through pores of the porous membrane, thereby inducing phase inversion in the polymer solution and causing a polymer in the polymer solution to precipitate out of the polymer solution to form a porous polymer coating adjacent to the porous membrane, wherein the porous polymer coating and the porous membrane together form the bi-layer separator; and
separating the bi-layer separator from the sacrificial support or the carrier belt.

15. A device, comprising:
a sacrificial support or a carrier belt; and
a bi-layer separator formed on the sacrificial support and removable from the sacrificial support, the bi-layer separator including:
a porous polymer coating in contact with the sacrificial support; and
a porous membrane adhered to the porous polymer coating.

16. The device as defined in claim 15 wherein the porous membrane is a non-woven mat selected from the group consisting of cellulose fibers, polyethylene naphthalate, aramid fibers, polyimide, and polyethylene terephthalate (PET).

17. The device as defined in claim 15 wherein the porous polymer coating is selected from the group consisting polyvinylidene fluoride (PVDF), polyetherimide, and meta-aramid.

18. The device as defined in claim 15 wherein the porous membrane of the bi-layer separator includes a porous polymer phase in some of its pores.
